(19) United States
(12) Patent Application Publication
(10) Pub. No.: US 2024/0376256 A1
(43) Pub. Date: Nov. 14, 2024

(54) ORGANIC BINDER, COMPOSITION FOR PRODUCING INORGANIC MATERIAL MOLDED ARTICLE, GREEN BODY, DEGREASED BODY, INORGANIC MATERIAL MOLDED ARTICLE, AND METHOD OF PRODUCING INORGANIC MATERIAL MOLDED ARTICLE

(71) Applicant: KUREHA CORPORATION, Tokyo (JP)

(72) Inventors: Takenori TOSE, Tokyo (JP); Takuma KOBAYASHI, Tokyo (JP); Takeshi MATSUMOTO, Tokyo (JP)

(73) Assignee: KUREHA CORPORATION, Tokyo (JP)

(21) Appl. No.: 18/578,163

(22) PCT Filed: Jun. 14, 2022
(86) PCT No.: PCT/JP2022/023800

§ 371 Date: Jan. 10, 2024

(30) Foreign Application Priority Data
Jul. 15, 2021 (JP) 2021-117314

(51) Int. Cl. C08G 63/06; B22F 3/10; C04B 35/634

(52) U.S. Cl. CPC C08G 63/06; B22F 3/1021; C04B 35/634; C08G 2170/00

(57) ABSTRACT

Provided is a binder that gives a green body with reduced brittleness and less susceptibility to fracture. An organic binder according to one aspect of the present invention is an organic binder to be used for molding a sinterable inorganic powder. The organic binder contains poly(glycolic acid) as a binder component.

### TECHNICAL FIELD

The present invention relates to an organic binder, a composition for producing an inorganic material molded article, a green body, a degreased body, an inorganic material molded article, and a method of producing an inorganic material molded article.

### BACKGROUND ART

Known is a method for obtaining a metal molded article, in which a metal injection molding is performed using a composition containing an inorganic material powder and a binder for binding the inorganic material powder, and this is heat-treated to obtain a metal molded article as a sintered body.

For example, Patent Document 1 discloses a molded article obtained by molding a composition for forming a molded article, the composition containing a powder and a binder, the powder mainly constituted by an inorganic material, the binder containing a resin degradable by the action of an alkaline gas.

In addition, Patent Document 2 discloses a method for obtaining a metal molded article, in which a metal powder composition containing a metal powder blended with a lactic acid polymer as an organic binder is used to obtain a green molded article by molding the composition, and the green molded article is heated to remove the lactic acid polymer and then heat-treated to obtain a metal molded article.

Furthermore, Patent Document 3 discloses a method for obtaining a sintered body, in which a molded article is formed using a composition containing a biodegradable resin as an organic binder component, the molded article is kept in water containing a degrading enzyme that exhibits an action of degrading the biodegradable resin to obtain a degreased body, and the degreased body is heated to obtain a sintered body.

Moreover, Patent Document 4 discloses a method for forming a three-dimensional object by extruding a feed material containing a binder system and a powder material dispersed in the binder system.

### CITATION LIST

### Patent Document

Patent Document 1: JP 2008-222535 A

Patent Document 2: JP 08-311504 A

Patent Document 3: JP 2000-038604 A

Patent Document 4: JP 2020-501941 A

### SUMMARY OF INVENTION

### Technical Problem

From the viewpoint of the shape or dimensional precision of a sintered body, the amount of a binder relative to an inorganic material powder is kept at approximately 1% in a minimum case. Thus, a green body is brittle and may disintegrate or fracture in degreasing and/or sintering operation, failing to obtain a desired shape. In addition, using a polymer that is itself highly flexible as a binder can reduce the brittleness. However, such a polymer has high fluidity and makes it difficult to obtain a green body in a shape of, for example, a single fiber.

Thus, the present invention has been made in view of the above issues, and an objective of the present invention is to provide a binder that gives a green body with reduced brittleness and less susceptibility to fracture.

### Solution to Problem

To solve the above issues, an organic binder according to one aspect of the present invention is an organic binder to be used for molding a sinterable inorganic powder, the organic binder characterized by including: poly(glycolic acid) as a binder component; and a degradation catalyst for the poly(glycolic acid) or a precursor of the degradation catalyst.

### Advantageous Effects of Invention

According to one aspect of the present invention, there can be provided

the organic binder that gives a green body less susceptible to fracture.

### DESCRIPTION OF EMBODIMENTS

Embodiments of the present invention will be described in detail below.

### Organic Binder

An organic binder is a binder to be used for molding a green body that is to be a precursor when a molded article is produced from an inorganic powder by a metal injection molding technique or the like and contains an organic material, such as a resin, as a binder component. The binder is removed (degreased) from the molded green body to obtain a degreased body, and the degreased body is heat-treated to obtain a final inorganic material molded article as a sintered body. The organic binder in the present embodiment contains poly(glycolic acid) as a binder component.

In the present specification, “poly(glycolic acid)” is intended to include not only a homopolymer having structural units derived from glycolic acid only but also a copolymer having structural units derived from glycolic acid and one or more types of other structural units. Examples of the other structural units include structural units derived from a carboxylic acid-based compound and structural units derived from an alcohol-based compound.

An example of the carboxylic acid-based compound includes oxalic acid, benzenedicarboxylic acid, methanedicarboxylic acid, phenylmethanedicarboxylic acid, ethanedicarboxylic acid, phenylethanedicarboxylic acid, propanedicarboxylic acid, phenylpropanedicarboxylic acid, butanedicarboxylic acid, phenylbutanedicarboxylic acid, pentanedicarboxylic acid, phenylpentanedicarboxylic acid, hexanedicarboxylic acid, phenylhexanedicarboxylic acid, heptanedicarboxylic acid, phenylheptanedicarboxylic acid, octanedicarboxylic acid, phenyloctanedicarboxylic acid, nonanedicarboxylic acid, phenylnonanedicarboxylic acid, decanedicarboxylic acid, phenyldecanedicarboxylic acid, dodecanedicarboxylic acid, phenyldodecanedicarboxylic acid, undecanedicarboxylic acid, phenylundecanedicarboxylic acid, ethenedicarboxylic acid, phenylethenedicarboxylic acid, propenedicarboxylic acid, phenylpropenedicarboxylic acid, butenedicarboxylic acid, phenylbutenedicarboxylic acid, pentenedicarboxylic acid, phenylpentanedicarboxylic acid, hexenedicarboxylic acid, phenylhexenedicarboxylic acid, heptenedicarboxylic acid, phenylheptenedicarboxylic acid, octenedicarboxylic acid, phenyloctenedicarboxylic acid, nonenedicarboxylic acid, phenylnonenedicarboxylic acid, decenedicarboxylic acid, phenyldecenedicarboxylic acid, dodecenedicarboxylic acid, phenyldodecenedicarboxylic acid, undecenedicarboxylic acid, phenylundecenedicarboxylic acid, ethynedicarboxylic acid, phenylethynedicarboxylic acid, propynedicarboxylic acid, phenylpropynedicarboxylic acid, butynedicarboxylic acid, phenylbutynedicarboxylic acid, pentynedicarboxylic acid, phenylpentynedicarboxylic acid, hexynedicarboxylic acid, phenylhexynedicarboxylic acid, heptynedicarboxylic acid, phenylheptynedicarboxylic acid, octynedicarboxylic acid, phenyloctynedicarboxylic acid, nonynedicarboxylic acid, phenylnonynedicarboxylic acid, decynedicarboxylic acid, phenyldecynedicarboxylic acid, dodecynedicarboxylic acid, phenyldodecynedicarboxylic acid, undecynedicarboxylic acid, phenylundecynedicarboxylic acid, hydroxybenzenecarboxylic acid, phenylhydroxyethanecarboxylic acid, hydroxypropanoic acid, phenylhydroxypropanoic acid, hydroxybutanoic acid, phenylhydroxybutanoic acid, hydroxypentanoic acid, phenylhydroxypentanoic acid, hydroxyhexanoic acid, phenylhydroxyhexanoic acid, hydroxyheptanoic acid, phenylhydroxyheptanoic acid, hydroxyoctanoic acid, phenylhydroxyoctanoic acid, hydroxynonanoic acid, phenylhydroxynonanoic acid, hydroxydecanoic acid, phenylhydroxydecanoic acid, hydroxydodecanoic acid, phenylhydroxydodecanoic acid, hydroxyundecanoic acid, phenylhydroxyundecanoic acid, hydroxypropenoic acid, phenylhydroxypropenoic acid, hydroxybutenoic acid, phenylhydroxybutenoic acid, hydroxypentenoic acid, phenylhydroxypentenoic acid, hydroxyhexenoic acid, phenylhydroxyhexenoic acid, hydroxyheptenoic acid, phenylhydroxyheptenoic acid, hydroxyoctenoic acid, phenylhydroxyctenoic acid, hydroxynonenoic acid, phenylhydroxynonenoic acid, hydroxydecenoic acid, phenylhydroxydecenoic acid, hydroxydodecenoic acid, hydroxyundecenoic acid, phenylhydroxydodecenoic acid, phenylhydroxyundecenoic acid, hydroxypropynoic acid, phenylhydroxypropynoic acid, hydroxybutynoic acid, phenylhydroxybutynoic acid, hydroxypentynoic acid, phenylhydroxypentynoic acid, hydroxyhexynoic acid, phenylhydroxyhexynoic acid, hydroxyheptynoic acid, phenylhydroxyheptynoic acid, hydroxyoctynoic acid, phenylhydroxyoctynoic acid, hydroxynonynoic acid, phenylhydroxynonynoic acid, hydroxydecynoic acid, phenylhydroxydecynoic acid, hydroxydodecynoic acid, phenylhydroxydodecynoic acid, hydroxyundecynoic acid, or phenylhydroxyundecynoic acid.

An example of the alcohol-based compound includes benzenediol, methanediol, phenylmethanediol, ethanediol, phenylethanediol, propanediol, phenylpropanediol, buthanediol, phenylbuthanediol, pentanediol, phenylpentanediol, hexanediol, phenylhexanediol, heptanediol, phenylheptanediol, octanediol, phenyloctanediol, nonanediol, phenylnonanediol, decanediol, phenyldecanediol, undecanediol, phenylundecanediol, dodecanediol, phenyldodecanediol, ethenediol, phenylethenediol, propenediol, phenylpropenediol, butenediol, phenylbutenediol, pentenediol, phenylpentenediol, hexenediol, phenylhexenediol, heptenediol, phenylheptenediol, octenediol, phenyloctenediol, nonenediol, phenylnonenediol, decenediol, phenyldecenediol, undecenediol, phenylundecenediol, dodecenediol, phenyldodecenediol, ethynediol, phenylethynediol, propynediol, phenylbutynediol, butynediol, phenylpropynediol, pentynediol, phenylpentynediol, hexynediol, phenylhexynediol, heptynediol, phenylheptynediol, octynediol, phenyloctynediol, nonynediol, phenylnonynediol, decynediol, phenyldecynediol, undecynediol, phenylundecynediol, dodecynediol, phenyldodecynediol, glycerin, or pentaerythritol.

Among them, the poly(glycolic acid) is preferably a glycolic acid homopolymer from the viewpoint of high strength. In addition, from the viewpoint of obtaining mechanical strength advantageous for maintaining the shape of the green body, the weight average molecular weight of the poly(glycolic acid) is preferably 1000 or greater and 1000000 or less, more preferably 10000 or greater and 500000 or less, and even more preferably 20000 or greater and 300000 or less.

Examples of a commercially available poly(glycolic acid) that can be used in the organic binder of the present embodiment include a Kuredux series, such as Kuredux 100R90 (available from Kureha Corporation).

The organic binder may contain one or two or more other resins in addition to the poly(glycolic acid) as a binder component to the extent that the effects of the present invention are not impaired. Examples of the other resins that can be contained in the organic binder include polyolefins, such as polyethylene and polypropylene; polyesters, such as poly(ethylene terephthalate), poly(butylene terephthalate), poly(lactic acid), and polycaprolactone; acrylic resins, such as polymethacrylate and poly(butyl methacrylate); polyethers, such as poly(methylene glycol), poly(ethylene glycol), and poly(propylene glycol); polyamides, such as nylon 6, nylon 11, nylon 12, nylon 66, nylon 610, nylon 6T, nylon 61, nylon 9T, and nylon M5T; vinyl resins, such as poly(vinyl chloride), poly(vinyl acetate), and poly(vinyl alcohol); polyoxazolines, such as poly-2-methyl-2-oxazoline, poly-2-ethyl-2-oxazoline, and poly-2-propyl-2-oxazoline; polycarbonate-based resins; poly(etherimide)-based resins; polysaccharides, such as cellulose, methylcellulose, sucrose, and sucralose, or copolymers of these; and commercially available pyrolysis binding polymers, such as QPAC (trade name) 25, QPAC (trade name) 40, QPAC (trade name) 100, QPAC (trade name) 130, and QPAC (trade name) PBC, which are available from Empower Materials Inc.

The organic binder may contain one or a combination of two or more additives, such as a plasticizer and an antioxidant, according to the purpose, such as imparting elasticity, rigidity, toughness, and plasticity.

The amount of the poly(glycolic acid) in the organic binder is preferably from 0.1 to 100 wt. %. As will be described later, the organic binder in the present embodiment contains poly(glycolic acid) as a binder component and thus is easily degreased under mild conditions. Thus, from the viewpoint of easy removability of the binder component in the green body, the amount of the poly(glycolic acid) in the organic binder is more preferably from 20 to 100 wt. %, and even more preferably from 50 to 100 wt. %.

In addition, using the organic binder containing poly(glycolic acid) as a binder component makes it possible to obtain a green body with reduced brittleness and less susceptibility to fracture.

Furthermore, because the binder component is poly(glycolic acid), the poly(glycolic acid) can be degraded by depolymerization reaction and removed from a green body when degreasing is performed by heat-treatment. Unlike pyrolysis reaction, which causes random degradation of a polymer chain, depolymerization reaction is a controlled degradation that proceeds from an end of the polymer chain. In pyrolysis reaction, which causes random degradation, a part of the polymer chain may remain in a degreased body. If a part of the polymer chain remains in the degreased body, it would remain as charcoal in a sintered body once the degreased body is heat-treated in the presence of oxygen. In contrast to this, depolymerization reaction can prevent a part of the polymer chain from remaining in the degreased body. That can prevent a part of the polymer chain from remaining as charcoal in the sintered body when the degreased body is heat-treated in the presence of oxygen. In addition, the depolymerization reaction of poly(glycolic acid) proceeds at a temperature lower than that of pyrolysis reaction. This allows degreasing to be performed under a lower temperature condition than that of pyrolysis.

### First Aspect of Organic Binder

In a first aspect of the organic binder of the present embodiment, the organic binder contains a degradation catalyst for the poly(glycolic acid) or a precursor of the degradation catalyst.

In the present specification, the “degradation catalyst for the poly(glycolic acid)” refers to a material that catalyzes a reaction for reducing the molecular weight of the poly(glycolic acid), specifically a hydrolysis reaction or a transesterification reaction. Specifically, the degradation catalyst is a salt containing a metal ion, an organic acid, or a base. Among them, the salt containing a metal ion or the organic acid act on the carbonyl group oxygen of poly(glycolic acid) as a Lewis acid catalyst to promote the hydrolysis reaction or the transesterification reaction. On the other hand, the base acts on the terminal functional group of poly(glycolic acid) as a Lewis base catalyst to promote the hydrolysis reaction or the transesterification reaction.

In the present specification, “reducing the molecular weight” means that poly(glycolic acid) is degraded to have a molecular weight less than that of the original poly(glycolic acid) and includes a change to a monomer, a dimer, or an oligomer.

Specific examples of the salt containing a metal ion, the salt functioning as the degradation catalyst, include organic or inorganic salts containing a metal ion, such as lithium ions, beryllium ions, sodium ions, magnesium ions, aluminum ions, potassium ions, calcium ions, scandium ions, titanium ions, vanadium ions, chromium ions, manganese ions, iron ions, cobalt ions, nickel ions, copper ions, zinc ions, gallium ions, germanium ions, rubidium ions, strontium ions, yttrium ions, zirconium ions, niobium ions, molybdenum ions, technetium ions, ruthenium ions, rhodium ions, palladium ions, silver ions, cadmium ions, indium ions, tin ions, cesium ions, barium ions, lanthanoid ions, hafnium ions, tantalum ions, tungsten ions, rhenium ions, osmium ions, iridium ions, gold ions, mercury ions, thallium ions, or lead ions. Among them, the salt is preferably an organic or inorganic salt containing titanium ions, germanium ions, zirconium ions, tin ions, or lanthanoid ions, and more preferably titanium ethoxide, titanium propoxide, titanium butoxide, titanium chloride, titanium sulfate, titanium hydroxide, titanium oxide, tetramethylgermane, tetraethylgermane, tetraphenylgermane, germanium chloride, germanium sulfate, zirconium hydroxide, germanium oxide, zirconium ethoxide, zirconium propoxide, zirconium butoxide, zirconium chloride, zirconium sulfate, zirconium oxide, tin butanoate, tin pentanoate, tin hexanoate, tin heptanoate, tin octanoate, tin nonanoate, tin decanoate, tin chloride, tin sulfate, tin hydroxide, or tin oxide.

Specific examples of the organic acid functioning as a degradation catalyst include organic carboxylic acid compounds, organic boric acid compounds, organic phosphoric acid compounds, and organic sulfonic acid compounds. Among them, the organic acid is preferably an organic carboxylic acid compound, an organic phosphoric acid compound, or an organic sulfonic acid compound, and more preferably an organic carboxylic acid compound. Specific examples of the organic carboxylic acid compound include formic acid, acetic acid, oxalic acid, malonic acid, succinic acid, glutaric acid, adipic acid, phthalic acid, 3,3′,4,4′-benzophenonetetracarboxylic acid, pyromellitic acid, ethyl phosphate, diethyl phosphate, propyl phosphate, dipropyl phosphate, butyl phosphate, dibutyl phosphate, propyl phosphate, dipropyl phosphate, hexyl phosphate, dihexyl phosphate, heptyl phosphate, diheptyl phosphate, octyl phosphate, dioctyl phosphate, p-toluenesulfonic acid, benzenesulfonic acid, methanesulfonic acid, or trifluoromethanesulfonic acid.

Specific examples of the base functioning as a degradation catalyst include organic amine compounds or heterocyclic compounds containing a nitrogen atom. Specific examples include pyrrole, indole, pyridine, aminopyridine, dimethylaminopyridine, quinoline, diazabicyclononene, or diazabicycloundecene.

In the present specification, the “precursor of the degradation catalyst” refers to a substance that does not act as a degradation catalyst itself but undergoes some action and changes its structure and becomes to function as a degradation catalyst accordingly. When the degradation catalyst is an organic acid, an ester of an organic acid and an alcohol or a phenol, or an anhydride of an organic acid corresponds to the precursor of the degradation catalyst, and specific examples include methyl formate, ethyl formate, propyl formate, butyl formate, pentyl formate, hexyl formate, heptyl formate, octyl formate, methyl acetate, ethyl acetate, propyl acetate, butyl acetate, pentyl acetate, hexyl acetate, heptyl acetate, octyl acetate, succinic anhydride, succinic anhydride, malonic anhydride, glutaric anhydride, adipic anhydride, phthalic anhydride, 3,3′,4,4′-benzophenonetetracarboxylic dianhydride (BTDA), pyromellitic dianhydride, triethyl phosphate, tripropyl phosphate, tributyl phosphate, tripropyl phosphate, trihexyl phosphate, triheptyl phosphate, trioctyl phosphate, methyl p-toluenesulfonate, ethyl p-toluenesulfonate, propyl p-toluenesulfonate, butyl p-toluenesulfonate, pentyl p-toluenesulfonate, hexyl p-toluenesulfonate, heptyl p-toluenesulfonate, octyl p-toluenesulfonate, methyl benzenesulfonate, ethyl benzenesulfonate, propyl benzenesulfonate, butyl benzenesulfonate, pentyl benzenesulfonate, hexyl benzenesulfonate, heptyl benzenesulfonate, octyl benzenesulfonate, methyl methanesulfonate, ethyl methanesulfonate, propyl methanesulfonate, butyl methanesulfonate, pentyl methanesulfonate, hexyl methanesulfonate, heptyl methanesulfonate, octyl methanesulfonate, methyl trifluoromethanesulfonate, ethyl trifluoromethanesulfonate, propyl trifluoromethanesulfonate, butyl trifluoromethanesulfonate, pentyl trifluoromethanesulfonate, hexyl trifluoromethanesulfonate, heptyl trifluoromethanesulfonate, or octyl trifluoromethanesulfonate. When the degradation catalyst is a base, an amide compound, an imine compound, a nitrile compound, or an isocyanate compound corresponds to the precursor of the degradation catalyst, and specific examples include formamide, acetamide, benzamide, N,N-dimethylformamide, acetanilide, glyoxal bis(2-hydroxyanyl), N-salicylideneaniline, benzophenone imine, benzylideneaniline, benzylidene-2-naphthylamine, N,N′-diphenylformamidine, 1,2-dicyanonaphthalene, 3,3′-iminodipropionitrile, butyl isocyanate, pentyl isocyanate, hexyl isocyanate, octyl isocyanate, phenyl isocyanate, methoxyphenyl isocyanate, naphthyl isocyanate, adamantyl isocyanate, xylylene isocyanate, or xylylene diisocyanate.

The amount of the degradation catalyst or the precursor of the degradation catalyst in the organic binder is preferably from 0.001 to 50 wt. %, more preferably from 0.001 to 40 wt. %, and even more preferably from 0.005 to 30 wt. % relative to the total amount of the organic binder including the degradation catalyst or the precursor of the degradation catalyst.

Depending on the compound, the degradation catalyst or the precursor of the degradation catalyst can also be a synthesis catalyst used in the production of the poly(glycolic acid). When such a compound is used as the degradation catalyst or the precursor of the degradation catalyst, the compound may be added during the production of the poly(glycolic acid) to use as a synthesis catalyst, and the compound remaining in the poly(glycolic acid) may be used as it is as the degradation catalyst or the precursor of the degradation catalyst to be contained in the organic binder. In addition, even when a compound that can also be utilized as the degradation catalyst or the precursor of the degradation catalyst is used as a synthesis catalyst in the production of the poly(glycolic acid), the same or different degradation catalyst or precursor may be separately added to the organic binder.

For the degradation catalyst and the precursor, only one may be used, or two or more may be used in combination.

The organic binder itself contains the degradation catalyst or the precursor of the degradation catalyst, and thus the removal of the binder component can be promoted without adding a catalyst or the like to the green body itself or a treatment liquid during degreasing treatment. In addition, a treatment liquid to which a degradation catalyst is added is not required, thus eliminating the need for immersing the green body in the treatment liquid, and this can provide a degradation-promoting effect by a catalyst also in degreasing by heat-treatment.

### Second Aspect of Organic Binder

In a second aspect of the organic binder of the present embodiment, the poly(glycolic acid) to be used is poly(glycolic acid) allowing a resin molded article to be obtained by molding the poly(glycolic acid) and to satisfy a condition (A) below:
(A) a weight reduction percentage in water at 80° C. for 7 days is 50% or higher.

Specifically, the condition (A) is a condition when the resin molded article is a filamentous molded article with a single fiber diameter of 20 μm. In addition, the weight reduction percentage in water at 80° C. for 7 days is measured by the following method. That is, 1 g of the molded article is placed in a vial, and 50 mL of deionized water is added to this. The vial is placed in a constant-temperature device at 80° C. and taken out after 7 days. The content of the vial is gravity-filtered using filter paper, and the degradation residue remaining on the filter paper is dried. The weight after drying is measured, and the reduction percentage from the initial weight is determined. The degradation residue is allowed to stand under drying conditions of 23° C. in a humidity environment with a dew point of −40° C. for 24 hours.

In addition, the poly(glycolic acid) in the present aspect is more preferably poly(glycolic acid) allowing the resin molded article described above to satisfy a condition (A′) below and is even more preferably poly(glycolic acid) allowing the resin molded article described above to satisfy a condition (A″) below.
(A′) A weight reduction percentage in water at 80° C. for 7 days is 70% or higher.
(A″) A weight reduction percentage in water at 80° C. for 7 days is 90% or higher.

Such poly(glycolic acid) exhibits excellent degradation in water even when present in the green body as a binder component. As a result, using the organic binder obtained using such poly(glycolic acid) can increase the removal rate of the binder component when the green body is immersed in water and degreased.

In addition, adjusting the crystallinity of the poly(glycolic acid) can achieve a desired weight reduction percentage in the molded article. For example, rapid cooling after heating and melting can produce poly(glycolic acid) with a low degree of crystallinity and increase the weight reduction percentage in water at 80° C. for 7 days. Furthermore, forming a copolymer of glycolic acid and another monomer species can also lower the degree of crystallinity and consequently can also increase the weight reduction percentage in water at 80° C. for 7 days. Examples of another monomer species include carboxylic acid-based compounds and alcohol-based compounds from which the structural unit of the copolymer described above is derived.

In addition, a hydrophilic chemical structure is contained in the polymer chain of the poly(glycolic acid), and this can incorporate a large amount of water required for hydrolysis into the polymer and can further accelerate the degradation of the binder component in water. For example, a structural unit with a hydrophilic chemical structure is contained as one of the structural units constituting the poly(glycolic acid), and this enables the polymer chain of the poly(glycolic acid) to contain the hydrophilic chemical structure.

Examples of the structural unit with a hydrophilic chemical structure include a polar chemical structure, such as, for example, a structural unit containing an ether functional group or an ester functional group. Specifically, the structural unit is derived from a hydroxycarboxylic acid excluding glycolic acid, or derived from a glycol or a dicarboxylic acid, and examples include structural units preferably derived from hydroxybenzenecarboxylic acid, phenylhydroxyethanecarboxylic acid, hydroxypropanoic acid, phenylhydroxypropanoic acid, hydroxybutanoic acid, phenylhydroxybutanoic acid, hydroxypentanoic acid, phenylhydroxy pentanoic acid, hydroxyhexanoic acid, phenylhydroxyhexanoic acid, methanediol, phenylmethanediol, ethanediol, phenylethanediol, propanediol, phenylpropanediol, butanediol, phenylbutanediol, pentanediol, phenylpentanediol, hexanediol, phenylhexanediol, glycerin, oxalic acid, benzenedicarboxylic acid, methanedicarboxylic acid, phenylmethanedicarboxylic acid, ethanedicarboxylic acid, phenylethanedicarboxylic acid, propanedicarboxylic acid, phenylpropanedicarboxylic acid, butanedicarboxylic acid, phenylbutanedicarboxylic acid, pentanedicarboxylic acid, phenylpentanedicarboxylic acid, hexanedicarboxylic acid, phenylhexane dicarboxylic acid, or the like.

The degradation catalyst or the precursor of the degradation catalyst described in the first aspect may be added to the organic binder in the second aspect.

### Composition for Producing an Inorganic Material Molded Article

The composition for producing an inorganic material molded article in the present embodiment contains a sinterable inorganic powder and the organic binder of the present embodiment.

In the present specification, the “sinterable inorganic powder” means a powder that can be sintered to form a solid when the powder is heated to its melting point or lower and a temperature at which a liquid phase is partially formed. Specific examples of the sinterable inorganic powder can be exemplified by metal powders, metal oxide powders, metal carbide powders, metal nitride powders, or metal boride powders. More specifically, examples of the metal powder include metal powders of iron, aluminum, copper, titanium, molybdenum, zirconium, cobalt, nickel, chromium, or the like, as well as alloy powders containing these metals as main components, such as stainless steel powders, high-speed powders, superalloy powders, and magnetic material powders. Examples of the metal oxide powder include powders of aluminum oxide, silicon oxide, zirconium oxide, titanium oxide, mullite, cordierite, beryllium oxide, thorium oxide, or the like. Examples of the metal carbide powder include powders of silicon carbide, boron carbide, zirconia carbide, titanium carbide, zirconium carbide, tungsten carbide, or the like. Examples of the metal nitride powder include powders of silicon nitride, aluminum nitride, boron nitride, titanium nitride, zirconium nitride, vanadium nitride, niobium nitride, or the like. Examples of the metal boride powder include powders of chromium boride, zirconium boride, or the like.

In one embodiment, the ratio between the inorganic powder and the organic binder in the composition for producing an inorganic material molded article is preferably from 1 to 30 parts by weight, more preferably from 1 to 20 parts by weight, and even more preferably from 1 to 10 parts by weight of the organic binder per 100 parts by weight of the inorganic powder.

The composition for producing an inorganic material molded article may contain an additive in addition to the inorganic powder and the organic binder. Examples of the additive include a dispersant (lubricant), a plasticizer, or an antioxidant. One additive can be used, or two or more additives can be used in combination. When an additive is contained in the composition for producing an inorganic material molded article, the content of the additive in the composition for producing an inorganic material molded article is preferably from 1 to 20 wt. %, more preferably from 1 to 10 wt. %, and even more preferably from 1 to 5 wt. %.

The components of the composition for producing an inorganic material molded article can be kneaded using a kneader of various types, such as a pressure or double-arm kneader, a roll kneader, a Banbury kneader, and a single-screw or twin-screw extruder. Poly(glycolic acid) is susceptible to hydrolysis, and thus the components are desirably kneaded in an atmosphere with the lowest possible dew point.

### Method of Producing an Inorganic Material Molded Article

Hereinafter, a method of producing an inorganic material molded article using the composition for producing an inorganic material molded article of the present embodiment will be described.

### Molding of Green Body

First, a green body, which is a molded article obtained by molding the composition for producing an inorganic material molded article into a predetermined shape, is obtained. The green body can be molded by a molding method of various types, such as, for example, an injection molding method, an extrusion molding method, a press molding method, and a calendar molding method. Among them, an injection molding method and an extrusion molding method are utilized in the process, and an injection molding method is particularly suitably utilized. Poly(glycolic acid) is susceptible to hydrolysis, and thus the green body is desirably molded in an atmosphere with the lowest possible dew point.

For the composition for producing an inorganic material molded article, a kneaded material itself may be used, or pellets granulated from the kneaded material may be used.

### Production of Degreased Body

The resulting green body is subjected to degreasing treatment to obtain a degreased body in which the binder component is removed from the green body. Many methods are known for degreasing treatment, but a method to be suitably used in the present embodiment is a method in which the binder component is degraded by water treatment or heat-treatment and removed.

The conditions of the water treatment in the degreasing by the water treatment is to be appropriately set according to the size and shape of the green body, the composition of the organic binder used, the composition of the composition for producing an inorganic material molded article used, and the like.

For example, the temperature of water is from 80 to 160° C., preferably from 80 to 150° C., and more preferably from 80 to 120° C.

In addition, the treatment time can be, for example, from 1 hour to 10 days, from 1 hour to 7 days, or from 1 hour to 3 days.

The water treatment can be performed by immersing the green body in water and allowing it to stand.

The conditions of the heat-treatment in the degreasing by the heat-treatment is also to be appropriately set according to the size and shape of the green body, the composition of the organic binder used, the composition of the composition for producing an inorganic material molded article used, and the like.

For example, the heat-treatment can be performed in an oxidizing, reducing, or inert gas atmosphere. In addition, the heat-treatment can be performed under reduced pressure, normal pressure, or increased pressure.

As described above, the degreasing by the heat-treatment in the present embodiment is not a pyrolysis reaction, which causes random degradation of the polymer chain, but the degradation of poly(glycolic acid) by depolymerization reaction, which proceeds from the end of the polymer chain. Thus, the temperature of the heat-treatment is to be a temperature at which the depolymerization reaction of poly(glycolic acid) proceeds, and is typically 200° C. or higher, preferably 210° C. or higher, and more preferably 220° C. or higher. In addition, the temperature of the heat-treatment is preferably a temperature at which the progress of pyrolysis reaction is suppressed, and is typically 300° C. or lower, preferably 280° C. or lower, and more preferably 250° C. or lower. The rate of temperature increase can be, for example, from 0.1° C./min to 100° C./min. The holding time after the temperature increase is, for example, from 1 hour to 50 hours. The heat-treatment environment may be increased pressure, atmospheric pressure, or reduced pressure, but is preferably reduced pressure. The heat-treatment atmosphere may be under air or hydrogen gas or under an inert gas, such as nitrogen gas, but is preferably under an inert gas.

### Production of Inorganic Material Molded Article

Heat-treating the resulting degreased body allows the inorganic powder in the degreased body to be sintered and an inorganic material molded article as a sintered body to be obtained. The conditions of the heat-treatment are to be appropriately set according to the size and shape of the degreased body, and the composition of the composition for producing an inorganic material molded article used. The heat-treatment can typically be performed in an oxidizing, reducing, or inert gas atmosphere. In addition, the heat-treatment can be performed under reduced pressure, normal pressure, or increased pressure. The heat-treatment temperature can be, for example, from 150 to 2000° C. The rate of temperature increase can be from 0.1° C./min to 100° C./min. The holding time after the temperature increase is, for example, from 10 minutes to 50 hours. The heat-treatment environment may be increased pressure, atmospheric pressure, or reduced pressure, but is preferably atmospheric pressure. The heat-treatment atmosphere may be under air or hydrogen gas or under an inert gas, such as nitrogen gas, but is preferably under an inert gas.

### Recapitulation

An organic binder according to one aspect of the present invention is an organic binder to be used for molding a sinterable inorganic powder, the organic binder containing: poly(glycolic acid) as a binder component; and a degradation catalyst for the poly(glycolic acid) or a precursor of the degradation catalyst.

In addition, the organic binder according to one aspect of the present invention contains a degradation catalyst for the poly(glycolic acid) or a precursor of the degradation catalyst.

Furthermore, in the organic binder according to one aspect of the present invention, the poly(glycolic acid) is poly(glycolic acid) allowing a resin molded article to be obtained by molding the poly(glycolic acid) and to satisfy a condition (A) below:
(A) a weight reduction percentage in water at 80° C. for 7 days is 50% or higher. The composition for producing an inorganic material molded article according to one aspect of the present invention contains 100 parts by weight of a sinterable inorganic powder and from 1 to 30 parts by weight of the organic binder described above.

A green body according to one aspect of the present invention is a green body formed by molding the composition for producing an inorganic material molded article described above.

A degreased body according to one aspect of the present invention is a degreased body in which the poly(glycolic acid) is removed from the green body described above.

An inorganic material molded article according to one aspect of the present invention is an inorganic material molded article formed by heat-treatment of the degreased body described above.

A method of producing an inorganic material molded article according to one aspect of the present invention includes:

molding the composition for producing an inorganic material molded article described above to obtain a green body;

depolymerizing the poly(glycolic acid) contained in the green body and removing the poly(glycolic acid) from the green body to obtain a degreased body; and

heat-treating the degreased body to obtain a molded article of an inorganic material.

A method of producing an inorganic material molded article according to one aspect of the present invention includes:

molding the composition for producing an inorganic material molded article described above to produce a green body;

degrading and removing the poly(glycolic acid) contained in the green body by bringing the green body into contact with water at 80 to 160° C. to obtain a degreased body; and

heat-treating the degreased body to obtain a molded article of an inorganic material.

Embodiments of the present invention will be described in further detail hereinafter using examples. The present invention is not limited to the examples below, and it goes without saying that various aspects are possible with regard to the details thereof. Furthermore, the present invention is not limited to the embodiments described above, and various modifications are possible within the scope indicated in the claims. Embodiments obtained by appropriately combining the technical means disclosed by the embodiments are also included in the technical scope of the present invention. In addition, all of the documents described in the present specification are herein incorporated by reference.

### EXAMPLES

### Measurement Methods

Measurement methods and/or measurement conditions for various physical properties in the following examples are as follows.

Weight Average molecular Weight

About 10 mg of a sample was dissolved by heating at 150° C. in 0.5 mL of dimethyl sulfate DMSO, and the solution was cooled to room temperature. The solution was diluted to 10 mL in a measuring flask with 1,1,1,3,3,3-hexafluoroisopropanol (HFIP) and measured. The measurement conditions are shown below.

Instrument: Shodex GPC-104 (detector, RI; columns, HFIP-606M×2)

Solvent: 5 mM CF₃COONa in HFIP

The weight average molecular weight was calculated using poly(methyl methacrylate) (PMMA) as a standard material.

### Thermogravimetry

About 10 mg of a sample was precisely weighed and set in a ceramic pan and measured under a nitrogen atmosphere. The measurement conditions are shown below.

Instrument: TGA/DSC3+

Temperature: increased from 25° C. at 10° C./min to 235° C. and kept for 10 min.

### Bending Modulus of Elasticity

Instrument: Autograph AG-2000E available from Shimadzu Corporation

Test piece shape: 13 mm in width, 3 mm in thickness, and 128 mm in length

Lower span: 48 mm

Test speed: 1 mm/min

Temperature: 23° C.

### Tensile Strength

Instrument: Autograph AG-2000E available from Shimadzu Corporation

Test piece shape: ASTM D638 Type-I

Distance between clamping jaws: 115 mm

Test speed: 50 mm/min

Temperature: 23° C.

### Example 1: Degradation Behavior in Water Treatment 1

### Preparation Example 1

Glycolide (available from Kureha Corporation, free acid concentration 2 eq/t) placed in a beaker was completely melted by heating to 100° C. in a dry room controlled at a dewpoint of −40° C. or lower. To the melt of glycolide were added 0.18 mol % of dodecylalcohol (available from Junsei Chemical Co., Ltd.) relative to glycolide and 5 ppm of tin dichloride dihydrate (available from Kanto Chemical Co., Inc.) relative to glycolide, and the mixture was stirred. After the mixture became uniform, the mixture was stirred for another 5 minutes. The melt was quickly transferred to a glass test tube and polymerized at 170° C. for 7 hours. The mixture was then cooled to room temperature and pulverized with a miller, and a poly(glycolic acid) (PGA) pulverized product was obtained. The pulverized PGA product was melt-kneaded with a twin-screw extruder (2D25S, available from Toyo Seiki Seisaku-sho, Ltd.), and PGA pellets were obtained. The weight average molecular weight of the resulting PGA was 220000. Into the PGA, tin dichloride dihydrate added at the time of polymerization is brought as it is and can function as a degradation catalyst.

Filaments with a single fiber diameter of 20 μm and a stretching ratio of 2 were spun from the resulting PGA pellets using a spinning machine “C0115” available from Fiber Extrusion Technology Ltd., and a test filament (Filament A1) for water treatment was obtained.

### Preparation Example 2

The PGA pellets obtained in Preparation Example 1 and poly(L-lactic acid) (PLLA; 4032D, available from NatureWorks LLC) were mixed in a weight ratio of 50:50, and tin dichloride dihydrate was further added at a final amount of tin dichloride dihydrate of 5 ppm, and a mixture of PGA, PLLA, and tin dichloride dihydrate was obtained accordingly.

A test filament (Filament B1) was obtained in the same manner as in Preparation Example 1 except that the mixture was used instead of the PGA pellets.

### Preparation Example 3

Tin dichloride dihydrate was added in an amount of 5 ppm relative to PLLA (4032D, available from NatureWorks LLC), and a mixture of PLLA and tin dichloride dihydrate was obtained accordingly. A test filament (Filament a1) was obtained in the same manner as in Preparation Example 1 except that the mixture was used instead of the PGA pellets.

### Evaluation of Degradation

Into a vial, 1 g of the test filament was weighed, 50 mL of deionized water was further added, and the vial was allowed to stand in a constant-temperature device at 80° C. After allowing to stand for 7 days, the content of the vial was filtered using filter paper weighed in advance and a funnel, and the filtered degradation residue was dried together with the filter paper. The degradation residue was allowed to stand under drying conditions of 23° C. in a humidity environment with a dew point of −40° C. for 24 hours. The weight of the residue and the filter paper was then measured, and the weight of the residue was obtained by subtracting the initial weight of the filter paper. The weight reduction percentage (wt. %) was calculated by dividing the difference between the weight of the residue and the initial weight of the test filament by the initial weight of the test filament. The results are shown in Table 1.

TABLE 1

| | Filament A1 | Filament B1 | Filament a1 |
|---|---|---|---|
| Binder component | PGA | PGA/PLLA | PLLA |
| Degradation catalyst | SnCl₂: 5 ppm | SnCl₂: 5 ppm | SnCl₂: 5 ppm |
| Weight reduction | 93 wt. % | 59 wt. % | 25 wt. % |
| percentage | | | |
| [7 days, 80° C.] | | | |

### Example 2: Degradation Behavior in Water Treatment 2

### Preparation Example 4

A test filament (Filament A2) for water treatment was obtained in the same manner as in Preparation Example 1 of Example 1.

### Preparation Example 5

A mixture of PGA and 3,3′,4,4′-benzophenonetetracarboxylic dianhydride (BTDA) was obtained by adding BTDA at a concentration of 9 wt. % relative to the PGA obtained in Preparation Example 1. A test filament (Filament A3) was obtained in the same manner as in Preparation Example 1 except that the mixture was used instead of the PGA pellets.

### Preparation Example 6

A test filament (Filament A4) was obtained in the same manner as in Preparation Example 5 except that 23 wt. % of BTDA was added.

### Preparation Example 7

A test filament (Filament a2) was obtained in the same manner as in Preparation Example 3 of Example 1.

### Evaluation of Degradation

The weight reduction percentage (wt. %) was calculated in the same manner as in Example 1 except that the period for allowing the vial containing the test filament and deionized water to stand was changed to 3 days. The results are shown in Table 2.

TABLE 2

| | Filament | Filament | Filament | Filament |
|---|---|---|---|---|
| | A2 | A3 | A4 | a2 |
| Binder component | PGA | PGA | PGA | PLLA |
| Degradation | SnCl₂: | SnCl₂: | SnCl₂: | SnCl₂: |
| catalyst | 5 ppm | 5 ppm | 5 ppm | 5 ppm |
| | | BTDA: | BTDA: | |
| | | 9 wt. % | 23 wt. % | |
| Weight reduction | 61 wt. % | 69 wt. % | 72 wt. % | 8 wt. % |
| percentage | | | | |
| [3 days, 80° C.] | | | | |

### Example 3: Degradation Behavior in Heat-Treatment

### Synthesis of PGA

A separable flask with a volumetric capacity of 1 L was charged with 1.3 kg of an aqueous solution of 70 mass % glycolic acid (available from Chemours Company, high purity grade). This was then heated with stirring by increasing the temperature from room temperature to 215° C., and polycondensation reaction was performed while formed water was distilled off. The pressure in the flask was then gradually reduced from atmospheric pressure to 3 kPa, then the reaction mixture in the flask was heated at 215° C. for 3 hours to distill off low-boiling point substances, such as unreacted raw materials, and poly(glycolic acid) (PGA) with a weight average molecular weight of 20000 was obtained.

### Evaluation of Depolymerization Rate

Iron chloride (II) or titanium tetrabutoxide, which is a degradation catalyst, was each added to HFIP, and an iron chloride (II)-containing solution and a titanium tetrabutoxide-containing solution were prepared. The iron chloride (II)-containing solution or the titanium tetrabutoxide-containing solution was each added to PGA, and PGA was dissolved in each solution. HFIP was then removed by drying under reduced pressure, and a degradation catalyst-containing PGA containing 1 mol % of the degradation catalyst.

The sample to which the iron chloride (II)-containing solution was added was used as Sample A, the sample to which the titanium tetrabutoxide-containing solution was added was used as Sample B, and the PGA to which no degradation catalyst was added was used as Sample C. Each sample was measured by thermogravimetry. The weight reduction rate (wt. %/h) was calculated by dividing the thermal weight reduction percentage for 10 minutes from the time when 235° C. was reached by time (10 minutes). The results are shown in Table 3.

TABLE 3

| | Sample A | Sample B | Sample C |
|---|---|---|---|
| Binder component | PGA | PGA | PGA |
| Degradation catalyst | FeCl₂: 1 mol % | Ti(OBu)₄: 1 mol % | — |
| Weight reduction | 48 wt. %/h | 56 wt. %/h | 20 wt. %/h |
| rate [10 min, | | | |
| 235° C.] | | | |

### Evaluation of Residual Amount of Organic Binder After Heat-Treatment

About 0.2 mg each of the PGA obtained in Preparation Example 1 and the PLLA obtained in Preparation Example 3 was weighed and analyzed by gas chromatography-mass spectrometry. The generation amount of depolymerized material (lactide or glycolide) per 0.1 mg of the resin was measured under conditions of 235° C. for 10 minutes. The results are shown in Table 4.

TABLE 4

| | | Under air | Under He |
|---|---|---|---|
| | | atmosphere | atmosphere |
| PGA | Generation amount of | 137240016 | 22194884 |
| (glycolide) | depolymerized material | | |
| | (area value) | | |
| PLLA | Generation amount of | 1118626 | 1572106 |
| (Lactide) | depolymerized material | | |
| | (area value) | | |

| | | |
|---|---|---|
| PLLA area value/PGA area value | 0.008 | 0.071 |

PGA appears to generate a larger amount of depolymerized material than PLLA, and a part of the polymer chain is considered less likely to remain in the degreased body.

### Example 4: Physical Property Measurement

Test pieces for tensile test and test pieces for bending test of PGA and PLLA were prepared by injection molding using an injection molding machine IS75E available from Toshiba Machine Co., Ltd. For PGA, the PGA obtained in Preparation Example 1 was used. For PLLA, the same PLLA as in Examples 1 and 2 (4032D, available from NatureWorks LLC) was used. Each test piece was allowed to stand in an oven at 120° C. under a nitrogen atmosphere for 1 hour and annealed, and then evaluated for tensile strength and bending modulus of elasticity. The results are shown in Table 5.

TABLE 5

| | PGA injection- | PLLA injection- |
|---|---|---|
| | molded piece | molded piece |
| Bending modulus of | 6.6 | 4.3 |
| elasticity (GPa) | | |
| Tensile strength (MPa) | 119 | 63 |

Although both PGA and PLLA are hydrolyzable polymers, PGA has both higher bending modulus of elasticity and higher tensile strength than PLLA. Thus, using PGA as a binder component can be said to provide a green body that is less deformed by an external force and less likely to be broken.

### INDUSTRIAL APPLICABILITY

The present invention can be utilized in a method of producing an inorganic material molded article.

1. An organic binder to be used for molding a sinterable inorganic powder, the organic binder comprising:
poly(glycolic acid) as a binder component, and
a degradation catalyst for the poly(glycolic acid) or a precursor of the degradation catalyst, wherein the poly(glycolic acid) allows a resin molded article to be obtained by molding the poly(glycolic acid) and to satisfy a condition (A) below:
(A) a weight reduction percentage in water at 80° C. for 7 days is 50% or higher.

2. (canceled)

3. A composition for producing an inorganic material molded article, the composition comprising 100 parts by weight of a sinterable inorganic powder and from 1 to 30 parts by weight of the organic binder described in claim 1.

4. A green body formed by molding the composition for producing an inorganic material molded article described in claim 3.

5. A degreased body, wherein the poly(glycolic acid) is removed from the green body described in claim 4.

6. An inorganic material molded article formed by heat-treating the degreased body described in claim 5.

7. A method of producing an inorganic material molded article, the method comprising:
molding the composition for producing an inorganic material molded article described in claim 3 to obtain a green body;
depolymerizing the poly(glycolic acid) contained in the green body and removing the poly(glycolic acid) from the green body to obtain a degreased body; and
heat-treating the degreased body to obtain a molded article of an inorganic material.

8. A method of producing an inorganic material molded article, the method comprising:
molding the composition for producing an inorganic material molded article described in claim 3 to produce a green body;
degrading and removing the poly(glycolic acid) contained in the green body by bringing the green body into contact with water at 80 to 160° C. to obtain a degreased body; and
heat-treating the degreased body to obtain a molded article of an inorganic material.
